(19) United States
(12) Patent Application Publication
(10) Pub. No.: US 2013/0047627 A1
(43) Pub. Date: Feb. 28, 2013

(54) METHOD FOR OPERATING AN IGCC POWER PLANT PROCESS HAVING INTEGRATED CO2 SEPARATION

(71) Applicant: Johannes Menzel, Waltrop (DE)

(72) Inventor: Johannes Menzel, Waltrop (DE)

(21) Appl. No.: 13/395,271

(22) PCT Filed: Sep. 17, 2010
(86) PCT No.: PCT/EP2010/063670

§ 371 Date: Mar. 23, 2012

(30) Foreign Application Priority Data
Sep. 30, 2009 (DE) 10 2009 043 499.2

(51) Int. Cl. F02C 6/00

(52) U.S. Cl. 60/780

(57) ABSTRACT

The invention relates to a method for operating an IGCC power plant process having integrated CO₂ separation. A process gas containing H₂ and CO₂ is separated into technically pure hydrogen and a fraction rich in CO₂ by means of pressure swing adsorption (PSA), wherein the fraction rich in CO₂ is released as PSA offgas by means of a pressure drop. The hydrogen that is generated is burned in at least one gas turbine utilized for generating electrical power, wherein the exhaust gas of the gas turbine is utilized for generating steam in a heat recovery boiler, said steam being expanded in a steam turbine process also utilized for generating electrical power. The PSA offgas is burned in a separate boiler using technically pure oxygen, wherein a smoke gas having a smoke gas temperature of greater than 1000° C. is generated. The smoke gas is utilized for superheating the steam fed into the steam turbine process and/or for generating a more pressurized steam for the steam turbine process. A superheated high-pressure steam having a pressure of greater than 120 bar and a temperature of greater than 520° C. is generated for the steam turbine process from the waste heat of the gas turbine and the waste heat of the smoke gas.

The invention relates to a method of operating an IGCC power plant having integrated CO₂ separation. IGCC stands for “integrated gasification combined cycle.” IGCC power plants are combined gas and steam turbine power plants that operate downstream of a stage for gasifying fossil fuels, in particular a plant for coal gasification, is arranged.

Gasification is a process that generates from fossil fuels a syngas that contains CO and H₂. The syngas is subjected to a CO conversion during which the carbon monoxide contained in the syngas is converted using steam into carbon dioxide and hydrogen. After the conversion, the syngas consists mainly of carbon dioxide and hydrogen. Chemical or physical gas scrubbers can remove the carbon dioxide from the syngas. The hydrogen-rich syngas is then burned in a gas turbine. With this concept for removing carbon dioxide, the overall efficiency deteriorates by about 10 percentage points with respect to a conventional gas and steam turbine power plant without CO₂ removal.

EP 0 262 894 describes a method of separating and producing CO₂ from a fuel that, besides hydrocarbons, contains H₂ and CO₂, where the feed gas is separated by means of pressure-swing adsorption (PSA) into a fraction of a technically pure hydrogen and a fraction rich in CO₂, the fraction rich in CO₂ also contains combustible gas and in particular H₂, and the fraction rich in CO₂ from the PSA plant is burned in a separate boiler using technically pure oxygen. Here, the waste heat can be used for generating steam, for example.

US 2007/0178035 describes a method of operating an IGCC power plant having integrated CO₂ separation. With the known method, a syngas containing CO and H₂ is generated from fossil fuels, where at least a partial flow of the syngas is converted in a CO-conversion stage by steam into H₂ and CO₂. The resulting process gas containing H₂ and CO₂ is separated by pressure-swing adsorption (PSA plant) into a fraction of technically pure hydrogen and a CO₂-rich fraction that contains combustible gases such as CO and H₂. The resulting hydrogen is burned in a gas turbine used for generating electrical power, the exhaust gas of the gas turbine being used for generating steam in a heat-recovery boiler, the steam being expanded in a steam-turbine process likewise used for generating electrical power. The CO₂-rich fraction resulting from the pressure-swing adsorption, which fraction is released by a cyclic pressure drop in the pressure-swing adsorption plant (PSA) and is designated hereinafter as “PSA off-gas”, is burned in a separate boiler using technically pure oxygen. The waste heat of the stack gas consisting of CO₂ and combustion products is used through heat exchange. With the known method, the waste heat of the stack gas is used for pre-heating the hydrogen flow used in the gas-turbine process.

WO 2006/112725 also describes a method with the above-described features. The CO₂-rich fraction from the pressure-swing adsorption is used as a fuel gas for heating a steam reformer by means of which syngas is generated. The stack gas generated during the combustion consists substantially of CO₂ and steam. The steam is separated and the residual flow substantially consisting of CO₂ is fed to a final disposal or recovery process.

The exhaust-gas temperature of the gas turbine of a conventional ICCC process is about 600° C. Higher exhaust-gas temperatures are not possible with conventional gas turbines, in particular for material-related reasons. By utilizing the waste heat of a gas turbine, only steam with a temperature of maximum 550° C. can be provided for the steam-turbine process. Also, the high gasification temperature during syngas generation cannot be used for a higher superheating of the steam because the syngas reduces the materials of the steam boiler so that permanent damage to the boiler would result. A conventional IGCC power plant process accepts that the steam-turbine process is operated with steam parameters (pressure and superheating temperature) that do not meet the level of a modern coal-fired power plant.

Against this background, it is an object of the invention to improve the overall efficiency of an IGCC power plant having integrated CO₂ separation.

The subject matter of the invention and solution for this object is a method according to claim 1. Based on a method with the features described above and given in the preamble of claim 1, the object is attain according to the invention in that by burning the CO₂-rich fraction generated during the pressure-swing adsorption, a stack gas having a temperature of more than 1000° C. is generated that is used for superheating the steam generated in the heat-recovery boiler arranged downstream of the gas turbine and/or for generating a higher pressurized steam for the steam-turbine process, and that the waste heat of the gas turbine and the waste heat of the stack gas generated during the combustion of the CO₂-rich fraction are used to make superheated high-pressure steam with a pressure of more than 120 bar and a temperature of more than 520° C., preferably more than 550 for the steam-turbine process.

Due to the oxygen-driven combustion of the PSA off-gas in a separate boiler, a stack gas substantially consisting of CO₂ and steam and having a temperature of more than 1000° C. is available. By utilizing the waste heat of this stack gas, compared to conventional IGCC processes, a higher steam superheating is possible, for example up to 600 to 700° C. so that accordingly the efficiency of the steam-turbine process of the IGCC plant can be significantly improved by the procedure according to the invention. Preferably, superheating to more than 550° C. is provided. An unavoidable efficiency loss of the gas-turbine process caused by the PSA off-gas missing in the syngas is at least partially compensated for this way. Thus, when applying the teaching according to the invention, the overall efficiency of an IGCC power plant having integrated carbon-dioxide separation deteriorates only insignificantly with respect to a conventional IGCC power plant without carbon-dioxide separation.

The method according to the invention uses a pressure-swing adsorption plant PSA (pressure-swing adsorption) for separating the converted syngas into a CO₂-rich and a hydrogen-rich fraction. When doing this, the converted syngas flows under high pressure into a first adsorber. The carbon dioxide contained in the gas is adsorbed. The hydrogen has only slight interaction with the adsorber mass and flows largely unchanged through the first adsorption apparatus. Once the absorption capacity of the adsorbent is exhausted, the syngas flow is diverted into a second adsorber. Then, the first adsorber is regenerated through pressure expansion, wherein the carbon dioxide separates from the adsorbent. The gas released during the pressure expansion is designated as “PSA off-gas.” It cannot be avoided that a portion of the hydrogen contained in the supplied syngas, for example 15% of the amount of hydrogen fed with the syngas, gets into the PSA off-gas so that the efficiency of the syngas generation is reduced. Thus, the off-gas consists to a large extent of carbon dioxide; however, it also contains hydrogen and carbon monoxide. Due to the high carbon-dioxide content, the PSA off-gas cannot be used for a conventional thermal combustion with air.

With the method according to the invention, the CO₂-rich PSA off-gas is burned using technically pure oxygen. Since the carbon dioxide has a higher molar heat capacity than nitrogen, a temperature is obtained that, despite the use of pure oxygen, corresponds approximately to the temperature of a fossil fuel combusted with air. Therefore, conventional furnaces can be used that are designed for burning fossil fuels using air.

The stack gas that discharges from the oxygen-operated PSA off-gas combustion consists almost exclusively of carbon dioxide and steam. It has proved to be particularly advantageous to avoid during the syngas generation that nitrogen gets into syngas. Preferably, for transfer and purging processes, carbon dioxide is used instead of nitrogen.

After the combustion of the CO₂-rich PSA off-gas using technically pure oxygen and the inventive utilization of waste heat for improving the steam parameters related to the steam-turbine process, the steam contained in the stack gas is cooled and condensed out so that subsequently a pure carbon-dioxide fraction is available. The latter can be fed to a final disposal process or can be used for “enhanced oil recovery” where the carbon dioxide is pumped under pressure into an oil reservoir, the pressure increasing and residual oil being forced to the surface.

Through the waste-heat utilization according to the invention, high-pressure steam can be readily generated at a pressure of more than 200 bar that enables the steam-turbine process to operate with good efficiency.

Within the steam-turbine process, a steam turbine can be used that is configured with multiple stages and has at least one high-pressure portion and one low-pressure portion. In the case of such a steam turbine it can then be provided that by means of the stack gas generated during the combustion of the CO₂-rich fraction, an intermediate superheating of the expansion steam from the high-pressure portion to a temperature of more than 520° C., preferably more than 550° C. takes place.

After the method according to the invention, a residual flow is left that consists substantially of CO₂. A portion of the generated CO₂ can be discharged and used during the generation of the syngas from fossil fuels, for example, for transporting the fuels and/or for purging and inertization purposes.

According to the invention, the stack gas generated during the combustion of the CO₂-rich fraction is used for superheating the steam generated in the heat-recovery boiler downstream of the gas turbine and/or for generating steam at higher pressure for the steam-turbine process. In order to achieve another increase in efficiency, the residual heat still contained in the CO₂-rich fraction can be used for preheating the CO₂-rich fraction prior to its combustion, and/or for preheating the technically pure oxygen supplied for the combustion.

The thermal utilization of the heat that is released during the combustion of the CO₂-rich PSA off-gas using pure oxygen preferably takes place in a boiler for steam generation. If the combustion temperature during the combustion of the PSA off-gas does not correspond to the required boiler temperature, this can be corrected by several measures that are described in patent claims 6 to 13 and explained below.

It has proven to be particularly advantageous to set the combustion temperature by controlling the portion of the syngas that is fed to the CO conversion. If the boiler temperature is too low, the amount of syngas fed to the conversion is reduced so that a greater portion of the syngas is conveyed past the CO conversion by partially bypassing it. If the boiler temperature is too high, the amount of syngas fed to the conversion is increased and a small portion of the syngas is conveyed past the CO conversion by partially bypassing it. In the case of a boiler temperature that is too high, it is also possible to subject all the syngas to conversion.

Furthermore, the combustion temperature can be set by the transformation in the CO conversion by providing a single-stage, two-stage or three-stage CO conversion. It is also possible to influence the transformation through the temperature in the conversion reactor. The greater the transformation of carbon monoxide into carbon dioxide, the lower is the combustion temperature that is obtained during the oxygen-operated combustion of the PSA off-gas.

Another possibility to influence the combustion temperature is a partial recirculation of the combustion gases that discharge from the oxygen-operated combustion of the PSA off-gas. The greater the portion of the combustion gases recirculated to the combustion, the more the combustion temperature decreases.

Another method variant of the method according to the invention provides that the stack gas temperature of the PSA off-gas combustion is raised by supplying syngas or combustion gas from other combustion-gas sources. Likewise, by adding a portion of the hydrogen-rich fraction to the combustion, it is possible to increase the temperature of the conversion of the CO₂-rich fraction using oxygen. Furthermore, low-calorific gases generated during the IGCC process can be fed to the oxygen-operated PSA off-gas combuster.

Advantageously, desulfurization is carried out already during syngas processing. The desulfurization can take place before or after the CO conversion. The exhaust gas of the oxygen-operated combustion of the PSA off-gas consists in this case almost exclusively of carbon dioxide and steam because the desulfurization was already carried out during the syngas processing.

In order that the exhaust gas generated during the combustion of the CO₂-rich fraction contains substantially only carbon dioxide and water, preferably, the crude syngas is already generated without nitrogen. It was found to be advantageous to use steam-fission reactions with no nitrogen involved for producing crude syngas or, in the case of partial oxidations, to use pure oxygen for producing the crude syngas. Moreover, it is preferred to use carbon dioxide for transfer and purging processes instead of nitrogen. It is particularly advantageous during the production of syngas by coal gasification to use carbon dioxide for the transport of the coal and for purging purposes.

It also lies within the invention to eliminate desulfurization in the syngas path and to desulfurize the stack gas generated during the PSA off-gas combustion by a conventional stack gas desulfurization.

Since with this method variant, the syngas is not desulfurized, all sulfur components together with the other PSA off-gas components get into the PSA off-gas. In the PSA off-gas combustion, the sulfur components are converted into SOₓ. The SOₓ components are separated from the CO₂-containing exhaust gas by conventional stack-gas desulfurization, for example by lime scrubbing with gypsum generation. As an alternative, there is also the possibility to remove the sulfur components contained in the PSA off-gas prior to the combustion using technically pure oxygen.

1. A method of operating an IGCC power plant process having integrated CO₂ separation, the method comprising the steps of:
generating from fossil fuels a syngas containing CO and H₂,
converting at least a a portion of the generated syngas in a CO-conversion stage by steam into H₂ and CO₂,
separating the generated H₂- and CO₂-containing process gas by a pressure-swing adsorption (PSA) into technically pure hydrogen, a CO₂-rich fraction that also contains gases such as CO and H₂, and a hot stack gas having a stack gas temperature of more than 1000° C.,
burning the resulting hydrogen in at least one gas turbine used for generating electrical power,
using the exhaust gas of the gas turbine and the hot stack gas from the pressure-swing adsorption in a heat-recovery boiler for generating superheated steam,
expanding the generated steam in a steam-turbine also used for generating electrical power,
burning the CO₂-rich fraction from the pressure-swing adsorption in a separate boiler using technically pure oxygen to create a stack gas,
using waste heat of the stack gas consisting of CO₂ and combustion products by heat exchange,
separating steam from the stack gas resulting from the combustion of the CO₂-rich fraction,
generating from waste heat of the gas turbine and waste heat of the hot stack gas a superheated high-pressure steam having a pressure of more than 120 bar and a temperature of more than 520° C. and feeding the superheated steam to the steam turbine, and
feeding a residual flow substantially consisting of CO₂ is fed to a final disposal or recovery process.

2. The method according to claim 1, further comprising the step of:
generating high-pressure steam with a pressure of more than 200 bar for the steam-turbine process.

3. The method according to claim 1, wherein the steam turbine has at least one high-pressure portion and one low-pressure portion, the method further comprising the step of:
using the stack gas generated during the combustion of the CO₂-rich fraction to superheat expansion steam from the high-pressure portion to a temperature of more than 520° C.

4. The method according to claim 1, wherein during the generation of syngas from fossil fuels, CO₂ is used for the transport of the fuels or for purging and inertization purposes in order to generate the syngas without nitrogen.

5. The method according to claims 1 to 4, further comprising the step, after superheating the steam in the heat-recovery boiler downstream of the gas turbine or after generating a higher pressurized steam for the steam-turbine process, of:
using the stack gas generated during the combustion of the CO₂-rich fraction for preheating the CO₂-rich fraction before its combustion or for preheating the supplied technically pure oxygen.

6. The method according to claim 1, further comprising the step of:
controlling the combustion temperature during the combustion of the CO₂-rich fraction by the content of combustible gases in the CO₂-rich fraction.

7. The method according to claim 1, further comprising the steps of:
conveying a portion of the syngas past the CO-conversion stage in a bypass and
controlling the volume flow conveyed in the bypass such that the temperature resulting from the combustion of the CO₂-rich fraction is controlled.

8. The method according to claim 1, further comprising the step, for reducing the stack gas temperature, of:
recycling a portion of the exhaust gas from the CO₂-rich fraction into the boiler for the combustion of the CO₂-rich fraction.

9. The method according to claim 1, further comprising the step of:
raising the stack gas temperature resulting from the combustion of the CO₂-rich fraction by feeding syngas or feeding fuel gas from other fuel gas sources.

10. The method according to claim 1, further comprising the step of:
desulfurizing the syngas before the CO conversion.

11. The method according to claim 1, further comprising the step of:
desulfurizing the syngas after the CO conversion.

12. The method according to claim 1, further comprising the steps of:
dropping pressure in the syngas to cause sulfur components to get into the CO₂-rich fraction generated during the pressure-swing adsorption, and
desulfurizing the CO₂-rich fraction before the combustion using technically pure oxygen.

13. The method according to claim 1, further comprising the step of:
dropping pressure in the syngas such that sulfur components in the syngas get into the CO₂-rich fraction generated during the pressure-swing adsorption
converting the sulfur components during the combustion of the CO₂-rich fraction into SOₓ, and
separating the SOₓ components by stack gas desulfurization from the CO₂-rich stack gas.
